(19) United States
(12) Patent Application Publication
(10) Pub. No.: US 2002/0146935 A1
(43) Pub. Date: Oct. 10, 2002

(54) HIGH RETENTION COAXIAL CONNECTOR

(76) Inventor: Shen-Chia Wong, Taipei (TW)

Correspondence Address: DOUGHERTY & TROXELL, Suite 1404, 5205 Leesburg Pike, Falls Church, VA, 22041, US

(21) Appl. No.: 09/827,148

(22) Filed: Apr. 6, 2001

(51) Int. Cl. H01R 9/05

(52) U.S. Cl. 439/583

(57) ABSTRACT

High retention coaxial connector, comprising: the body which consists of an annular collar, the annular collar in turn incorporates an annular toggle and a first contact spring, a coupling which consists of an annular collar and a second contact spring. The connector on the whole together with the coupling will compel both the first contact spring and the second contact spring into forming a wavy, elastic clamping means against the central conductor and the aluminum shield of the coaxial cable being worked with, at the final lockup position.

### BACKGROUND OF THE INVENTION

(1) Field of the Invention

This invention provides a high retention coaxial connector, characterized in that when the connector on the whole and the coupling are locked in a final lockup position, by the interactive compression between the collar on both sides, the toggle will crinkle radially, to result in electromechanical integration by the clamping force created by the contact spring in the toggle against the aluminum shield and the central conductor of the coaxiable cable that is being worked with.

(2) Description of the Prior Art

In common cable TV systems, wireless TV systems and Collective Antenna TV system it is common practice to run a mater trunk line to the distributor, wherefrom sub-truck line is fed to user's terminals, so that at these terminals signals transmitted by the TV emission systems are received. It is at the tail ends of coaxial cable that the trunk line is coupled to cable connector, and in that manner, assembled to the distributor, such as is shown in FIG. 1A, a coaxial connector that is currently in use nowadays, the purpose of the coaxial connector in the main is to secure optimum coupling between the coaxial shield and the connector body, which is prerequisite to the transmission of electric signals. The coaxial connector 100 comprises a connector body 101, a first coupling sleeving 102, screwed onto one end of the body 101, and a second coupling sleeving 103, screwed unto one end of this first coupling sleeving 102. The connector body 101 comprises an annular collar 104, a damper 105 coaxially assembled within the collar 104, as well as moisture-sealing gasket 106 installed way between the internal surface of the body 101 and the terminal end of the collar 104. A harness 107 is coaxially installed inside the second coupling sleeving 103, and a contact 108 is coaxially installed inside the harness 107. A wedge 116 is abutted upon the damper 105.

As shown in FIG. 1B, the damper 105 is executed to be an annular foil comprising a pipette 110, with both sides configured to yield several protrusion detents 111, which may get caught into the bulging wall 119 on the collar 104, thereby confining the damper 105 into the annular 104. Referring to FIG. 1C, it will be appreciated that coaxially installed into the second sleeving 103 is a contact 108 of which one end, the contact end 112, may be coupled with the distributor to consummate electric connection, whereas another end, being the clamp end 113, is endowed with inner threads 114 in addition to a plurality of grooves 115.

Structured accordingly, what must be done in the first place as the coaxial connector 100 and the cable 200 are to be assembled together, is to have the loose end of the cable stripped ready so that outer coating 118 is left naked clear of both the aluminum shield 116 and the core leader 117, next, insert the cable 200 thus prepared into the body 101 of the connector, thirdly, combine the body 101 with the first coupling sleeving 102 by intertwining each other, while the damper 105 by its interiority wraps up the aluminum shield 116 tight, and fourthly, the body 101 of the connector into which cable 200 has been established is screwed with the second sleeving 102 to unity, with the ultimate culminating in having the core leader 117 of the cable inserted into the inner threads 114 of the contact 108. Structured accordingly, the core leader 117 is compelled to wind up secured by the contact 108, and electric connection is consummated.

The assemblage procedure disclosed in the foregoing renders immediately conventional mode assemblage of coaxial connector awkward and cumbersome which invariably lowers or restricts working efficiency on the part of the working staff. Moreover, with the interior part of the damper 105 tightly wrapping up the external part of the aluminum shield 116, in a rigid to rigid encounter, weathering effects or other causes, such as, for example heat expansion and cold shrinkage, due to climatological change, wind blown vibration, fatigue or material rigidity, can much often bring the damper 105 to aluminum shield 116 clamping force loose, and that eventually frustrating the good bond between the coaxial shield and the connector body, what follows in suit is impaired performance of transmission of electric signals, all the more so in dealing with digital transmission services. To prevent all that possibility, working technicians on duty will have to clamp tight the connector body 101 against the first coupling sleeving 102 again each year, and then that simply resulting in additional cost expense, and time spent, for that reason it deserves deliberation for other solutions.

In view of the above discussions, the inventor, verily a professional having been engaged in the art for years, had spent time and labor, energy in working for improvement, and has finally brought up this invention, high retention coaxial connector.

### SUMMARY OF THE INVENTION

Accordingly, the primary object of the invention is to provide a high retention coaxial connector, with the body of the connector equipped with a first contact spring which will compel the aluminum shield of the cable into electromechanical bonding to thereby assure reliable electric connections.

A further object of the invention is to provide a high retention coaxial connector, whereof the body of the connector is internally mounted with a second contact spring which will compel the core leader of the cable that is being worked with into electromechanical integration so as to assure reliable electric conduction.

### BRIEF DESCRIPTION OF THE DRAWINGS

Technical measures employed to serve the above mentioned purposes and characteristic features are to be demonstrated by way of examples covered hereinafter with reference to the accompanying drawings in which:

FIG. 1A is a section view of a prior art coaxial cable connector.

FIG. 1B is a three-dimensional perspective of a prior art clamper.

FIG. 1C is a three-dimensional perspective of a prior art contact.

FIG. 2 is a section view of the invention coaxial connector.

FIG. 3 is a section view of the body of the connector structured according to the invention;

FIG. 3A is a section view of what is pursuant to the line segment 3A-3A as given in FIG. 3.

FIG. 4 is a section view of the column part of the invention.

FIG. 5 is a section view of the pipe element of the invention;

FIG. 6A is a section of the toggle of the invention;

FIG. 6B is a three-dimensional perspective of the contact spring of the invention.

FIG. 7 is an illustration of the invention seen from the body of the connector, the body of the coupling means, the cable lockup through approximation to the final position.

FIG. 8 is a section view of that segment from the lockup through the final position pursuant to FIG. 7.

FIG. 8A is a section view of the segment 8A-8A taken from FIG. 8.

FIG. 9 is a section view of the body of the coupling means of the invention;

FIG. 10 is a section view of the first insulator pursuant to the invention;

FIG. 11 is a section view of the second insulator pursuant to the invention.

FIG. 12 is a section view of the contact element of the invention.

FIG. 13A is a section view of the annular collar of the invention.

FIG. 13B is a section view of the contact spring of the invention.

FIG. 14 is a section view of the coaxial connector of the invention.

FIG. 15A is an illustration of the invention in going from the body of the connector, the body of the coupling means, and the cable locked up to approximate the final position; and

FIG. 15B is a section view of consummation of lockup to the final position pursuant to the illustration of FIG. 15A.

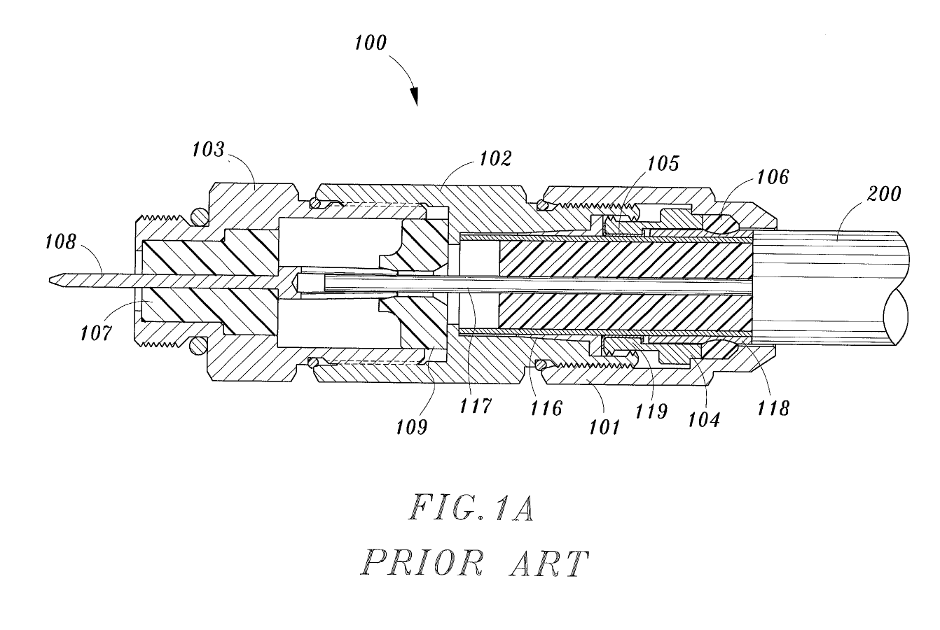

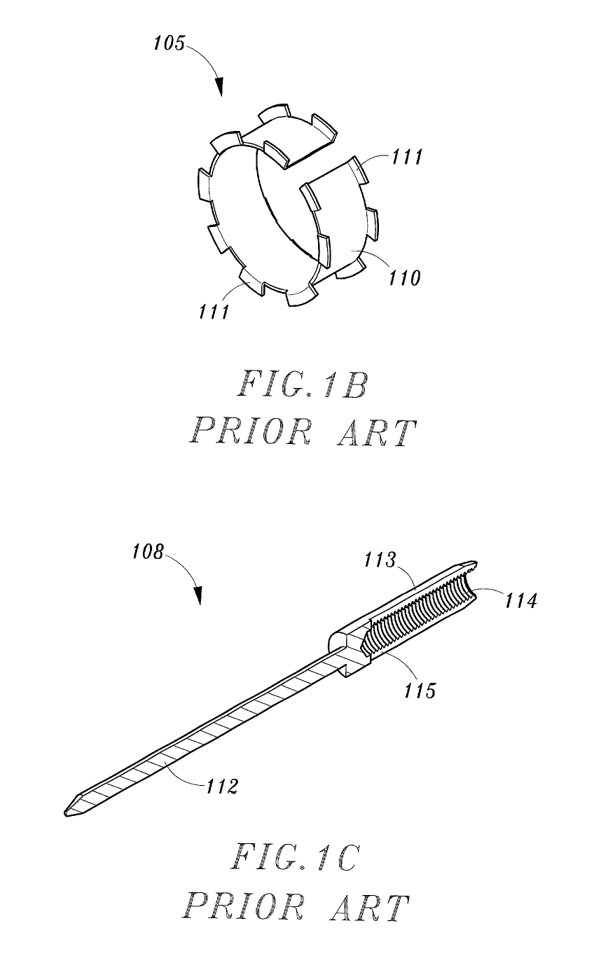

### DETAILED DESCRIPTION OF THE PREFERRED EMBODIMENT

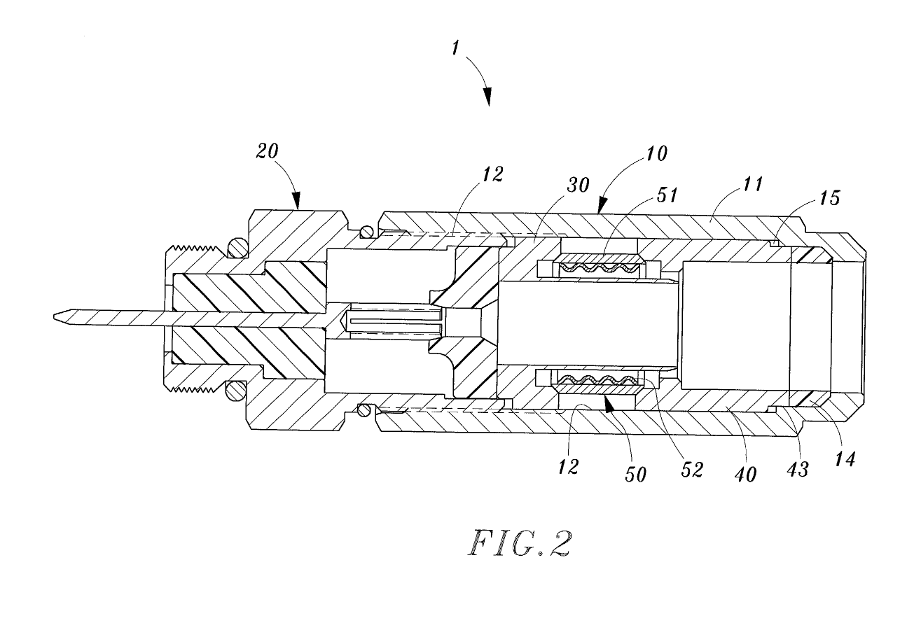

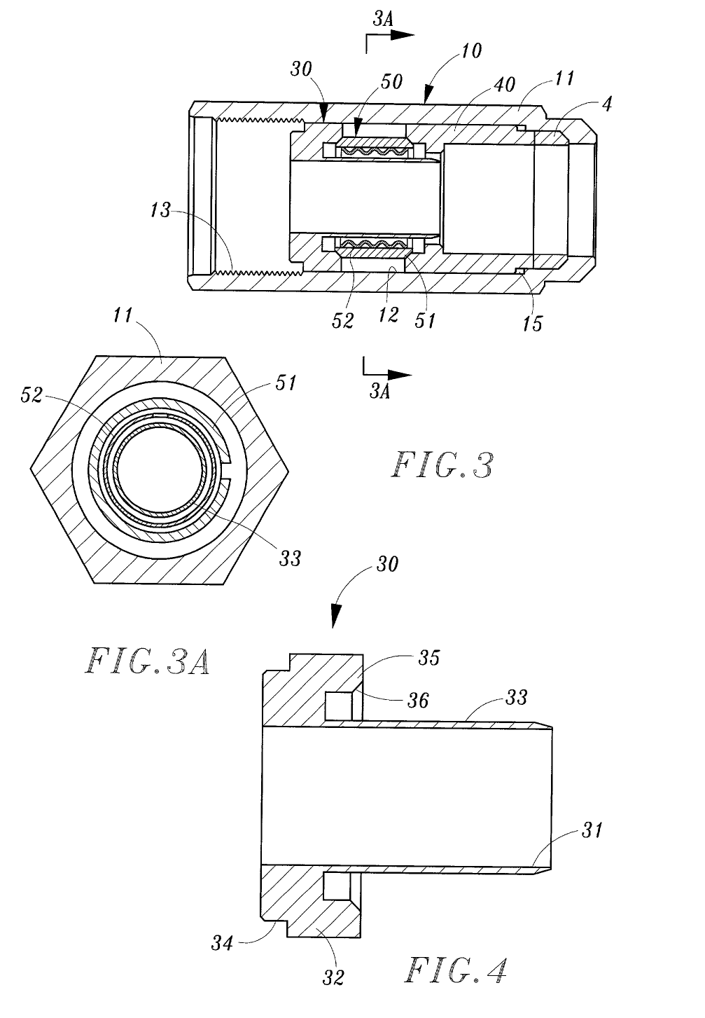

Referring first of all to FIG. 2, a panoramic view of the longitudinal section of the high retention coaxial connector 1 structured according to the invention, it will be seen that the coaxial connector 1 comprises the body 10 and a coupling proper 20 integral therewith, referring to FIG. 3 altogether, it will seen that said body 10 of the connector is composed of a body 11 integral with a container hole 12 thereon, the container hole 12 further contains a threaded bore 13 which is coaxially furnished with an annular column 30, an annular pipette 40, an annular collar 50, and a moisture-sealing gasket 14.

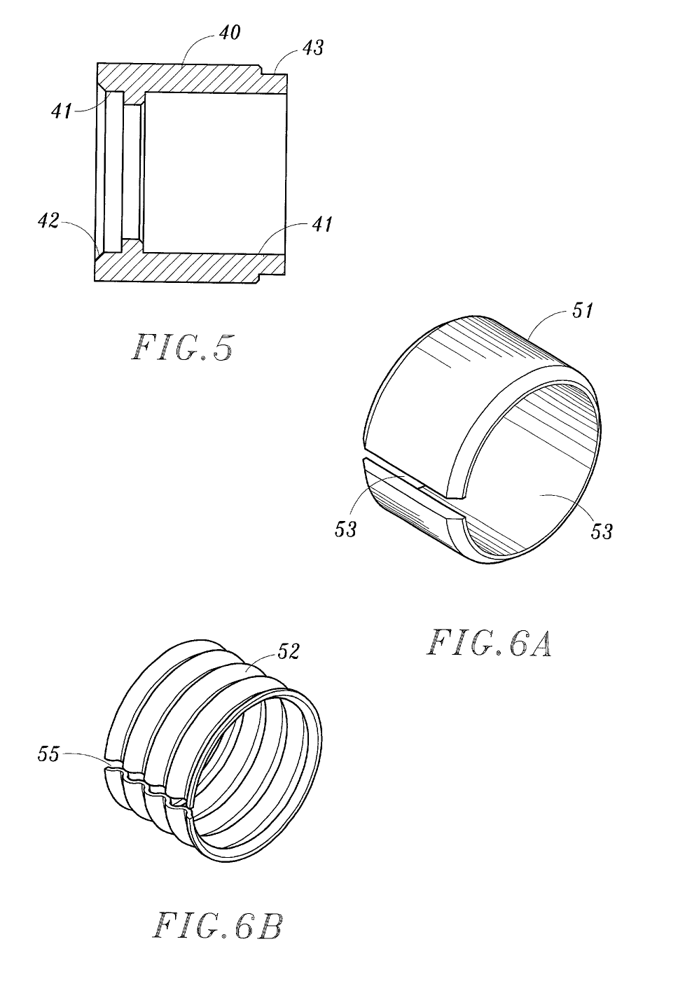

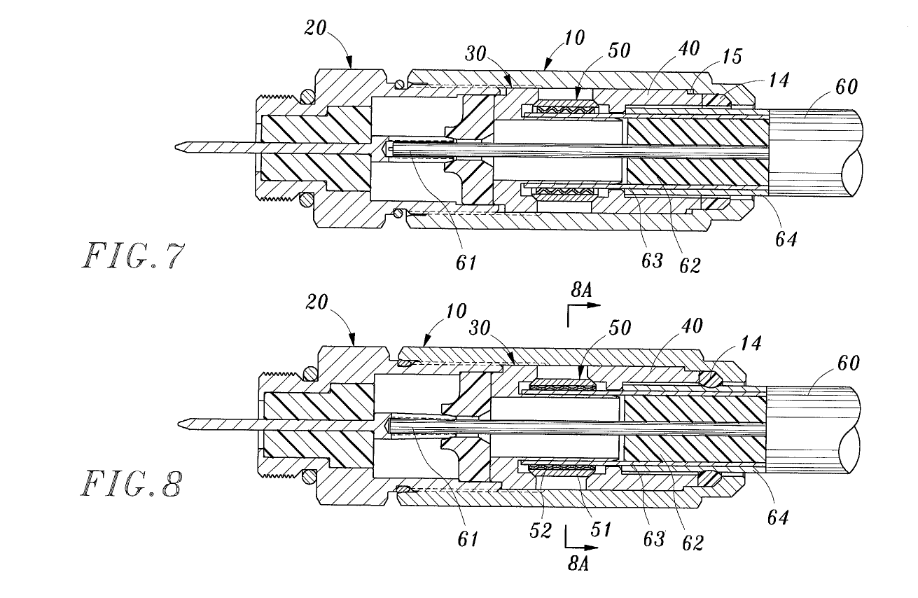

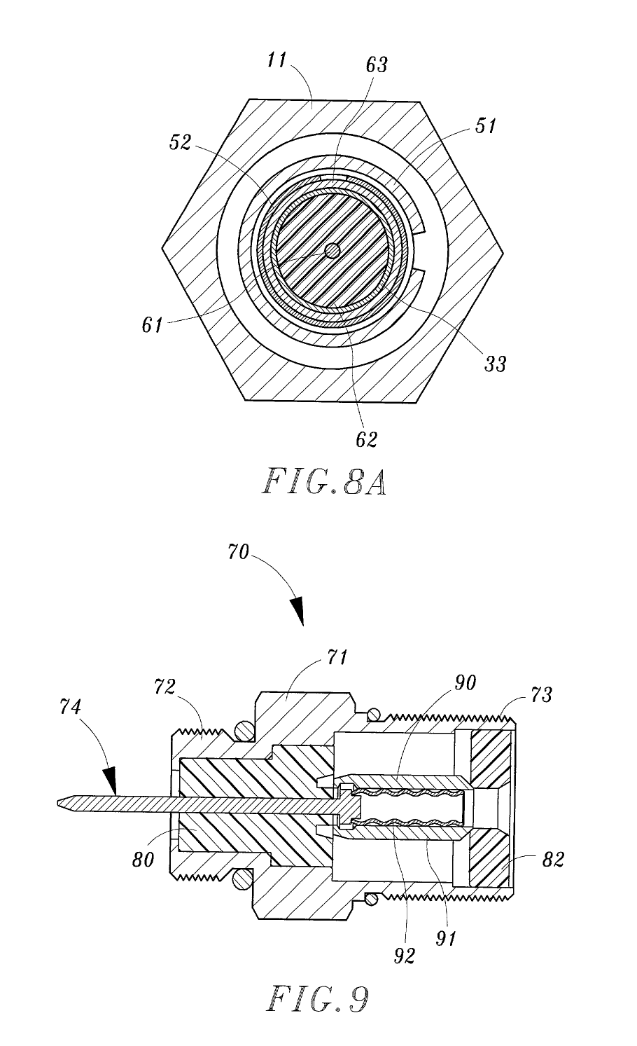

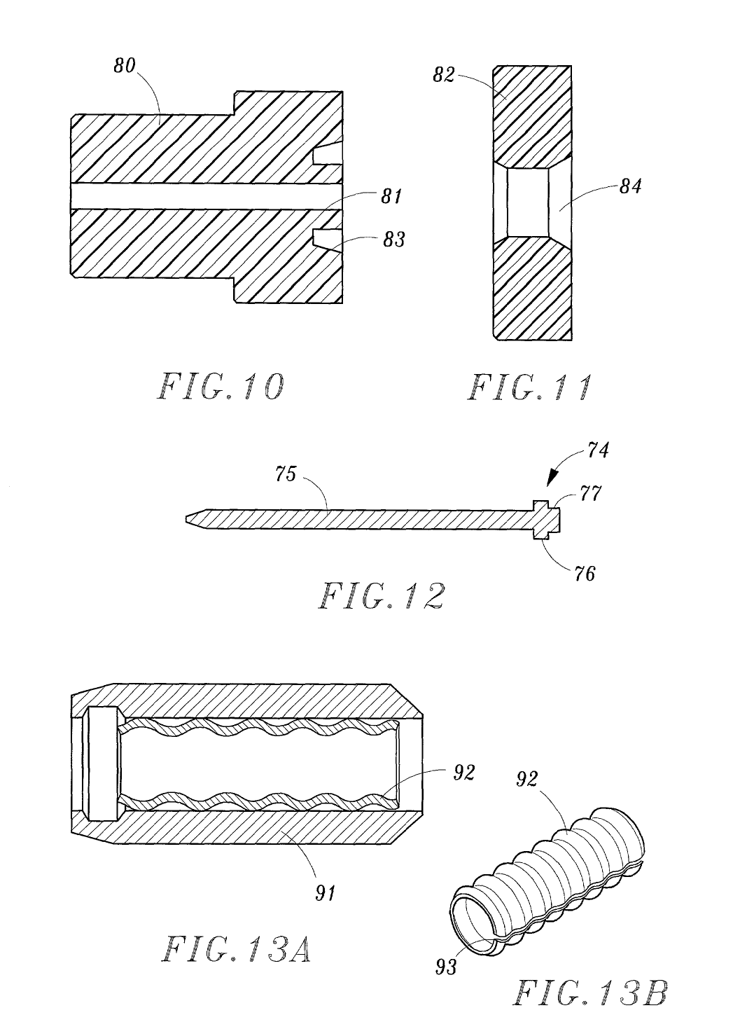

Represented by the section view of FIG. 4 is an example of the annular column 30 which is preferably made from metals, and the column 30 is penetrated by drilled holes 31 whose dia. just fits to accommodate the insulator 62 for the coaxial cable 60, as would be better appreciated by referring to FIG. 8. The column piece 30 is processed to yield a flange 32 and a pipe section 33. The flange 32 is configured with an annular shoulder 34 and an annular rim 35 which is tapered 36 within.

Represented in the cross section view of FIG. 5 is an example of the annular pipe element 40, which is preferably made from metals complete with a drilled hole 41 whose end is processed into a conic section 42, on the end outside of the pipe section 40 there is formed an annular shoulder 43 which is spaced apart from the interiority of the body 11 by a gap 15.

As shown in FIG. 3, FIG. 3A, the annular collar 50 is mounted way between the column 30 and the pipe element 40, and incorporates a toggle 51 and a first contact spring 52. Represented in the three-dimensional view of FIG. 6A is an example of the toggle 51 which incorporates a drilled hole 53 whose dia. is such that it will just accommodate a contact spring 52. On the toggle 51 is formed a coulisse 54 to allow for flexibility in view of possible deformations of the toggle 51. As shown in FIG. 6B, the first contact spring 52 can be such one that is made from metal base such as, for example, resilient steel, structured by a series of annular ring, and on said first contact spring 52 is formed a coulisse 55 so as to exhibit a flexible retention force. The first contact spring 52 has its inner dia. sized so that accommodation of the aluminum shield 63 of the cable is possible (reference called to FIG. 8).

In both FIG. 7, FIG. 8 are represented altogether an example of the invention high retention coaxial connector 1 in combination with a coaxial cable 60. The cable 60 consists of a central conductor 61, insulator 62, aluminum shield 63 and hard coating 64. As a first step, prepare in order the free end of the coaxial cable 60, next, slide the connector as a whole 10 into the cable 60, as a third step lock up the connector body 10 with the coupling proper 20 such that as both of them are locked to approaching the final position, the coupling proper 20 will compel the column 30, the pipe element 40, and the annular collar 50 present in the connector body 10 to move toward the other end, as would be better appreciated by referring to FIG. 7, by then the pipe element 40 will fill up the gap 15.

When both the connector body 10 and the coupling proper 20 are established in the final lockup position, the very fact that the moisture-hermetic gasket 14, duly compressed by the pipe element 40, will expand to form a moisture-hermetic seal (see FIG. 8), while the annular collar 50, duly compressed by the column 30 in conjunction with the pipe element 40, will bring about a radial contraction of the toggle 51, the same radial contraction will subject the first contact spring 52 into a tightup clamping, albeit flexible, of the aluminum shield 63 of the coaxial cable 60, and all that effort designed to assure prolonged and reliable electric conduction or connection thereby secured (see FIG. 8). As the final step, the central conductor 61 of the coaxial cable 60 is to be inserted into the coupling unit 21 relative to the connector on the whole 20, to consummate transmission of electric signals.

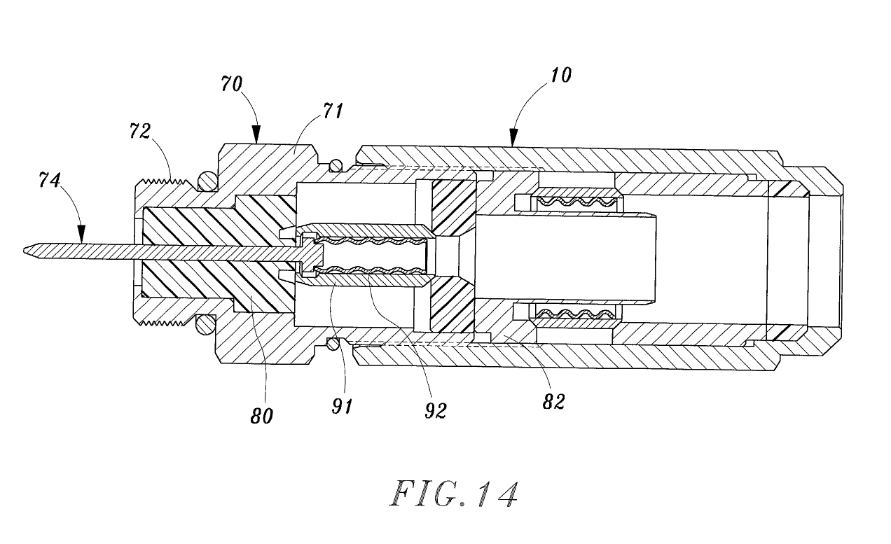

Represented in the section view of FIG. 9 is an example of the connector body 70 which comprises: the body 71, a first insulator 80 arranged within, a second insulator 81 arranged on the other end of the body 71, a contact unit 74 coaxially arranged in the first insulator 80, plus an annular collar 90 arranged way between the first insulator 80 and the second insulator 81. The terminal end on the outer side of the body 71 is furnished with threads 72, 73; with threads 72 being helically coupled to electronic implements, and threads 73 helically coupled to the connector body 10 (see FIG. 14).

Represented in the section view of FIG. 10 is an example of the first insulator 80 which is penetrated by a drilled hole 81 whose dia. is dimensioned to just accommodate the contacts 75 of the contact unit 74. On the edge front of the first insulator 80 is formed an annular groove 83.

Represented in the section view of FIG. 11 is an example of the second insulator 82 which is entertained with an insert hole 84 to yield to the intermission of the central conductor 61 that is part of the cable 60.

Represented in FIG. 12 is an example of the contact unit 74, which consists of a contact piece 75, a flange 76 and an annular shoulder 77.

Represented in FIG. 13A, in a section view, is an example of the annular collar 90 which consists of a toggle 91 and a second contact spring 92 that is coaxially arranged therein. In the three-dimensional perspective of FIG. 13B is an example of the second contact spring 92 comprising a plurality of annular rings connected in series, on top which is formed a coulisse 93 serving to yield a forcible but resilient clamping force. By one of its ends the second contact spring 90 is united to the annular shoulder 77 of contact unit 74 (see FIG. 14).

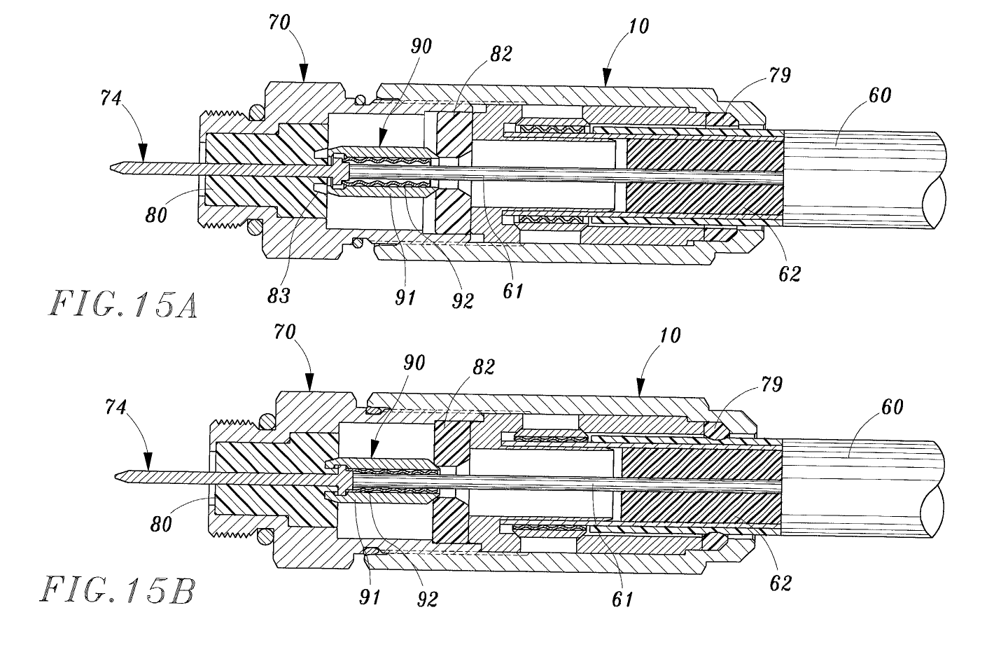

Represented in the section view of FIG. 14 is an example of the invention with the connector on the whole 70 being locked up with the coupling proper 10. Referring to the section views of both FIG. 15A and FIG. 15B, representing altogether one instance whereof the coaxial cable 60 pursuant to FIG. 14 is integrated too, the working procedure starts with preparing the free end of the coaxial cable 60, as a first step, the next is to slide the connector body 10 into the cable 60, followed thirdly by locking up the connector body 10 with the coupling proper 70, and, as both the connector body 10 and the coupling proper 70 are being locked to the point of approaching the final position, the moisture-sealing gasket 79 will get duly compressed to expand to accomplishing the moisture-hermetic sealing, while in the meantime one end of the toggle 91 gets caught into the annular coulisse 83, until the terminal of the central conductor 61 comes flush with the contact front of the contact unit 74, by then, the central conductor 61 of the cable 60 rests inserted in the second contact spring 92, as being compressed by both the first insulator 80 and the second insulator 82, the annular collar 90 will force the toggle 91 to shrink radially, such a radial contraction will induce a wavy pattern on the part of the second contact spring in a first dimension, thereby compelling the second contact spring 92 into exerting a flexible but tightup clamping of the central conductor 61 of the coaxial cable 60, and that serving to assure a prolonged and secure electric conduction or connection. As a final step, the central conductor 61 of the coaxial cable 60 is inserted by way of the contact unit 21 into the connector body 20, to consummate transmission of electric signals (reference called to FIG. 15B). What follows in suit, then, is electric conduction being established between the central conductor 61 and the coupling proper 74.

Summing up the disclosure going thus in the foregoing it can be appreciated that with the central conductor 61 of the coaxial cable 60, as pursuant to the invention, together with the aluminum shield 63 being simultaneously subjected to compressed albeit flexible clamping by the first and the second contact springs 52, 92, a desired optimum electromechanical bonding is consummated sufficient to warrant a prolonged and reliable electric conduction. That the connector body and the coupling proper will suffice to modulate both the first and the second contact springs 52, 59, into a wavy pattern at the final lockup position, predicts a tightup clamping with respect to the aluminum shielding as well as to the central conductor of the cable that is being worked with.

The disclosure going thus far, together with drawings and examples covered hereinbefore, serve but as several embodiments of the invention but by no means to restrict the invention; and it shall be such that all and any modifications, variants, changes made with respect to the invention disclosed herein, to the extent practicable by parties and persons skilled in the art shall nonetheless be deemed within the scope of the invention as defined precisely in the claims following next in the text.

What is claimed is:

1. High retention coaxial connector, serving to connect electromechanically a running length of coaxial cable to a distributor or to a clutch, the coaxial cable comprising: a central conductor, aluminum shielding, insulators, and outlying coating; whereas the coupling means comprisese:
the connector as a whole, the body, serving to accept the coaxial cable coaxially;
the coupling assembly with one end accommodating for coupling with the connector as a whole, and the other end thereof attached to said distributor or clutch; and,
an annular collar, serving to bring the coaxial cable united to the connector as a whole by a high retention force, and comprising: a toggle and a first contact spring, coaxially arranged in said toggle, such that once both the connector as a whole and the coupling assembly run through to the last lockup position, the first contact spring, compressed radially by the annular collar, will exhibit a flexibly applied but rigorous clamping effect upon the aluminum shielding of the cable, and that sufficient to assure a prolonged, reliable electric conduction.

2. High retention coaxial connector according to claim 1, whereof said first contact spring is preferably composed of a number of annular ring connected serially and having a coulisse formed thereon to facilitate radial deformation of the first contact spring, duly contracted to a wavy pattern when receiving radial impact coming from said toggle, so as to account for a flexibly applied compression clamping against the said aluminum shielding.

3. High retention coaxial connector according to claim 1, whereof the connector as a whole further comprises an annular collar and a contact unit, the annular collar being connected by a high retention force to the central conductor of the coaxial cable and further incorporating a toggle and a second contact spring that is coaxially arranged in said toggle such that once both the connector as a whole and the coupling assembly are locked up to a final lockup position, the second contact spring by reason of receiving a radial compression imposed by the toggle on course will exhibit a flexibly applied rigorous clamping effect upon the central conductor of the cable, to thereby compel the central conductor into electromechanical bonding with contact unit, and that sufficient to warrant a long standing reliable electric conduction.

4. High retention coaxial-connector according to claim 1, whereof said second contact spring is preferably composed of a number of rings connected serially on top of which is formed a coulisse which is functional in subserving to the presentation of a wavy pattern as the second contact spring is compressed by the functioning toggle in the radial orientation to thereby exerting a flexibly applied rigorous clamping effect upon the central conductor that forms part of the coaxial cable that is being worked with all the while.
